(19) United States
(12) Patent Application Publication
(10) Pub. No.: US 2003/0015693 A1
(43) Pub. Date: Jan. 23, 2003

(54) SCREW JACK

(75) Inventor: Yasuji Kawasaki, Fujieda-shi (JP)

Correspondence Address: Paul Fields, Darby & Darby, P.C., 805 Third Avenue, New York, NY, 10022, US

(73) Assignee: Kawasaki Industrial Co., Ltd

(21) Appl. No.: 09/911,185

(22) Filed: Jul. 23, 2001

(51) Int. Cl. B66F 3/18

(52) U.S. Cl. 254/103

(57) ABSTRACT

The present invention relates to a screw jack that has a thin metal bearing for supporting a main screw shaft of a jack body to lift the jack body high as possible so that a torque increase can be kept to a minimum. For this purpose, the metal bearing is mounted and configured to have a substantially large outer diameter, and also a small stepped sliding-surface is formed on the top or bottom surface of the metal bearing.

### BACKGROUND OF THE INVENTION

1. Field of the Invention

This invention relates to a screw jack used for raising a structural object or a work piece, and more particularly to a screw jack that utilizes a screw.

2. Description of the Prior Art

The conventional automatic three-stage screw jack, as shown in FIG. 6, is structurally designed to equip a ball bearing C on a bed B at a lower end of an external cylinder A to receive and support a screw shaft D on the ball bearing C. Therefore, there is a disadvantage that the jack is able to raise an object only up to a level from which the thickness of the ball bearing has subtracted.

### SUMMARY OF THE INVENTION

An object of the present invention is to provide a screw jack that is able raise an object up to a higher level in comparison with the conventional one.

According to the present invention, there is provided a screw jack that comprises a thin metal bearing arranged on a bottom surface of a jack body, where the thin metal bearing receives and supports a main screw shaft on the jack body. The thin metal bearing is constructed so as to have a large outer diameter while a stepped sliding-surface is constructed so as to have a small diameter and provided on the top or bottom surface of the large-diameter metal bearing.

### BRIEF DESCRIPTION OF THE DRAWINGS

FIG. 1 is a vertical cross sectional front view of the screw jack in accordance with the present invention;

FIG. 2 is a front view that illustrates a condition in which the screw jack is being elevated high;

FIG. 3 is a set of a plan view FIG. 3-a, a vertical cross sectional view FIG. 3-b and a bottom view FIG. 3-c for illustrating an exemplified metal bearing to be installed on the screw jack of the present invention;

FIG. 4 is a set of a plan view and a vertical cross sectional front view for illustrating another exemplified metal bearing to be installed on the screw jack of the present invention;

FIG. 5 is a set of a plan view and a vertical cross sectional front view for illustrating still another exemplified metal bearing to be installed on the screw jack of the present invention; and

FIG. 6 is a front view of the conventional screw jack.

### DETAILED DESCRIPTION OF THE PREFERRED EMBODIMENTS

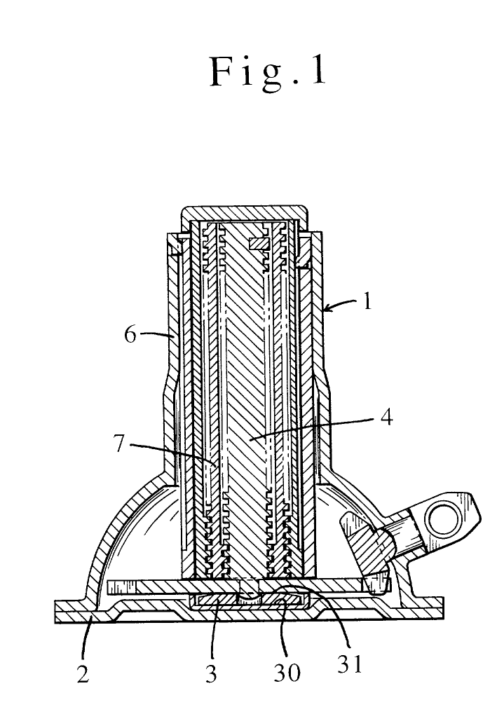

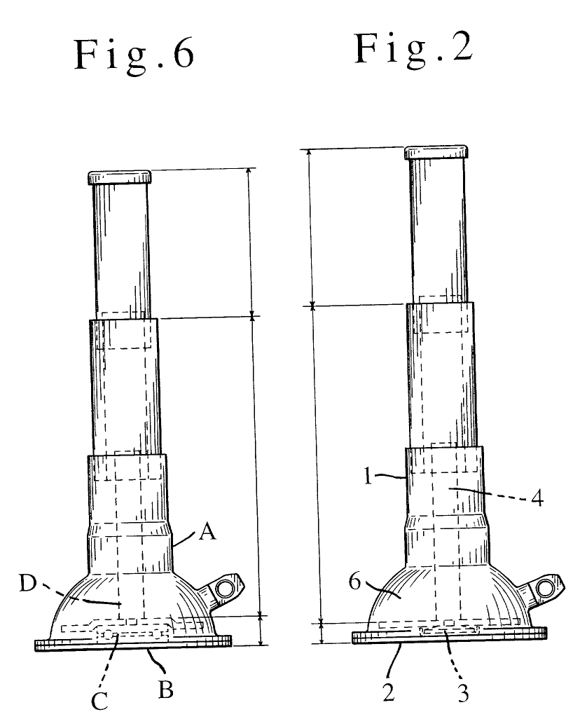

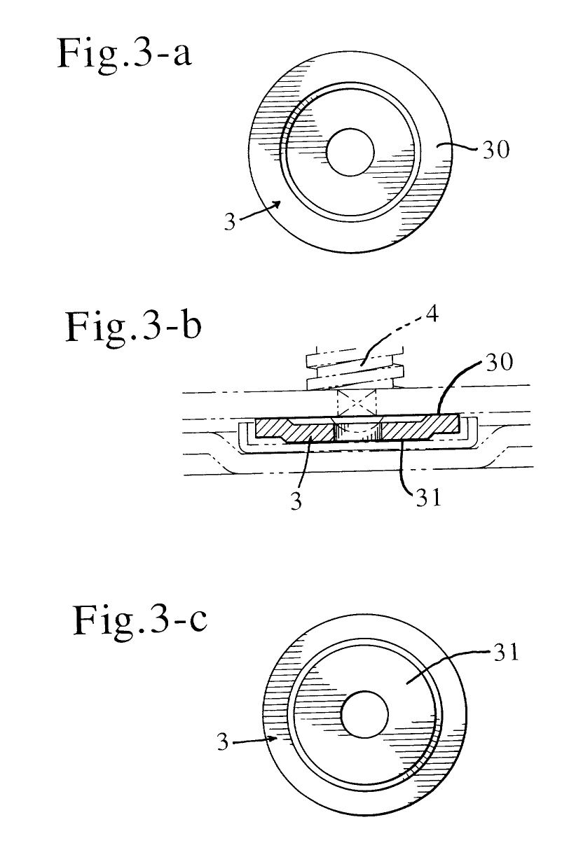

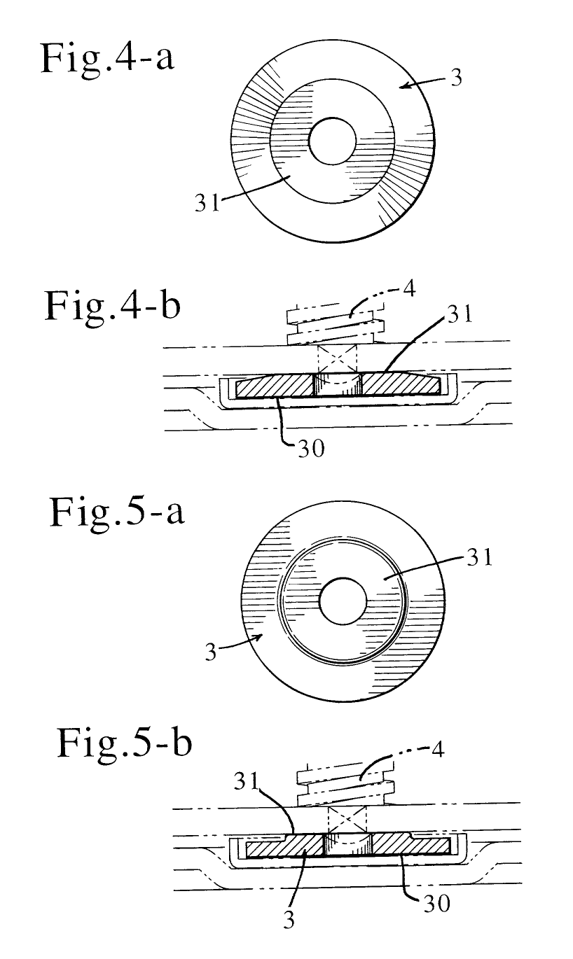

A screw jack as one of preferred embodiments of the present invention will be described with reference to FIGS. 1 to 5.

Reference numeral 1 denotes a jack body where a metal bearing 3 is installed on a bed 2 arranged on a lower end of the jack body and a main screw shaft 4 stands on the bed 2 by being received and supported by the metal bearing 3. The metal bearing 3 is structurally designed to have a substantially large outer diameter in comparison with the conventional one. In addition, a stepped sliding surface 31 is formed on the top or bottom surface of the metal bearing 31. The stepped sliding surface 31 is structurally designed to have a small turning-radius to relatively facilitate its sliding action for keeping a torque increase to a minimum. In the present invention, the outer diameter of the metal bearing is enlarged in the design in advance so that it may be easy to be materialized and it may be excellently stabilized. Thus, only the size of the sliding surface 31 is lessened to keep a torque increase to a minimum by facilitating its sliding action. Furthermore, reference numeral 6 denotes a case and 7 denotes an external cylinder.

According to the present invention, as described above, the thickness of the metal bearing is substantially smaller than that of the conventional ball bearing, so that the jack body is of a high level type, compared with the conventional one, resulting in excellent features of the jack. In addition, the metal bearing is structurally designed to have a large diameter in comparison with that of the conventional one, so that it ensures stability. Furthermore, a stepped sliding surface is formed on the top or bottom surface of the metal bearing and structurally designed to have a small turning-radius, so that its sliding action is facilitated and a torque increase can be kept to a minimum.

What is claimed is:

1. A screw jack comprising:
a jack body;
a main screw shaft that stands on the jack body;
a thin metal bearing arranged on a bottom surface of a jack body; and
a stepped sliding-surface formed on the top or bottom surface, wherein
the thin metal bearing receives and supports the main screw shaft on the jack body and is constructed so as to have a large outer diameter, while the stepped sliding-surface is constructed so as to have a small diameter.
